(19) United States
(12) Patent Application Publication
(10) Pub. No.: US 2008/0200194 A1
(43) Pub. Date: Aug. 21, 2008

(54) System and method for transforming and transmitting data between terminals

(75) Inventors: Li-Jun Dai, Nanking City (CN); Xiao-Dong Zhang, Nanking City (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 12/010,862

(22) Filed: Jan. 30, 2008

(30) Foreign Application Priority Data
Feb. 16, 2007 (TW) 096105981

(51) Int. Cl. H04Q 7/20

(52) U.S. Cl. 455/466

(57) ABSTRACT

The invention discloses a system for transforming and transmitting data. The system according to the invention includes a platform, a first terminal, a second terminal, and a transforming module. The platform is capable of providing multimedia data and a text input interface. The first terminal connects to the platform and selects the multimedia data. A user can input text data in the text input interface through the first terminal. The transforming module converts the text data to voice data, and transmits the multimedia data and the voice data to the second terminal.

### BACKGROUND OF THE INVENTION

1. Field of the Invention

This invention relates to a system and a method for transforming and transmitting data, and more particularly, to a system and a method for transforming and transmitting data between terminals.

2. Description of the Prior Art

In prior arts, a user only can read the content of a text data through a mobile communication device and transmit the text data in text form to other members to read, but cannot transform the text data to voice data and then transmit it to other members. In addition, although users can connect to a website to download cell phone ringtones, songs, or videos through mobile communication devices, the foregoing multimedia data cannot be transmitted with the text data which is transformed to the voice data to other members simultaneously.

For instance, after selecting a text message (such as a blessing, a joke, an e-book, or a weather forecast) in a website through a mobile communication device, a user cannot transmit the text message with the multimedia data (such as the foregoing ringtones, songs, and videos) to other members simultaneously. The disadvantage of the prior arts is that they cannot put diversified message services into practice.

Accordingly, the objective of the invention is to provide a method for transforming and transmitting data to solve the above-mentioned problem.

### SUMMARY OF THE INVENTION

A scope of the invention is to provide a system for transforming and transmitting data. In a preferred embodiment of the invention, the system includes a platform, a first terminal, a second terminal, and a transforming module. The platform is capable of providing multimedia data and a text input interface. The first terminal is used for connecting to the platform and selecting the multimedia data. A user is capable of inputting text data in the text input interface through the first terminal. The transforming module is capable of converting the text data to voice data, and transmitting the multimedia data and the voice data to the second terminal.

Another embodiment according to the invention is a method for transforming and transmitting data. A platform provides multimedia data and a text input interface. The method adopts a step of connecting to the platform through a first terminal and selecting the multimedia data, inputting text data in the text input interface through the first terminal. After that, the method adopts a step of converting the text data to voice data. Finally, the method adopts a step of transmitting the multimedia data and the voice data to the second terminal.

The system and the method according to the invention are capable of converting text data to voice data before transmitting the text data, and the content of the text data can be read by playing the voice data. Moreover, the system and the method according to the invention are capable of transmitting the voice data and multimedia data by a terminal to another terminal at the same time. Thus, a user can receive the content of the text data with diversified ways and enjoy the multimedia data.

The advantage and spirit of the invention may be understood by the following recitations together with the appended drawings.

### BRIEF DESCRIPTION OF THE APPENDED DRAWINGS

FIG. 1A and FIG. 1B are schematic diagrams illustrating a system for transforming and transmitting data according to an embodiment of the invention.

FIG. 2A, FIG. 2B and FIG. 2C are flow charts showing a method for transforming and transmitting data according to another embodiment of the invention.

### DETAILED DESCRIPTION OF THE INVENTION

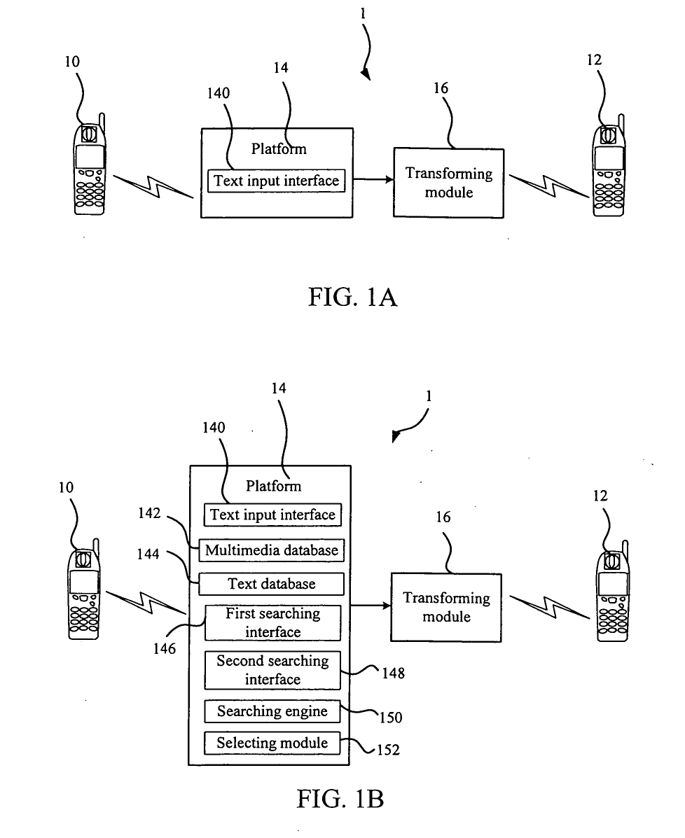

Please refer to FIG. 1A. FIG. 1A is schematic diagram illustrating a system 1 for transforming and transmitting data according to an embodiment of the invention. As shown in FIG. 1A, the system 1 includes a first terminal 10, a second terminal 12, a platform 14, and a transforming module 16.

In a practical application, the first terminal 10 and the second terminal 12 can be mobile terminals or wired terminals. The foregoing mobile terminals can be mobile communication devices such as mobile phones, and the wired terminals can be personal computers or indoor phones.

The platform 14 is capable of providing multimedia data and a text input interface 140. The platform 14 can be called resource server, which is meant to be a resource provider distributed within any communication network. In a practical application, the multimedia data can be audio data, such as ringtones or pop music songs. The first terminal 10 is used for connecting to the platform 14 and selecting the multimedia data. Furthermore, a user is capable of inputting text data (such as a blessing or a joke) in the text input interface 140 through the first terminal 10.

After the text data is inputted, the transforming module 16 is capable of converting the text data to voice data, and transmitting the multimedia data and the voice data to the second terminal 12. In a practical application, the transforming module 16 is capable of transmitting the multimedia data and the voice data to the second terminal 12 after a predetermined time or transmitting immediately after the text data is converted to the voice data.

In the embodiment, the transforming module 16 can transmit the multimedia data and the voice data to the second terminal 12 through an IP-PBX (IP-private branch exchange, not shown in FIG. 1A). The IP-PBX is used to replace telecommunication analog exchanges and analog phones originally used in enterprises by Internet phones and call servers. Enterprises can decrease the costs of building and assembling of lines by only one data network without building the data network for computers and the lines of analog exchanges for ordinary phones at the same time.

Please refer to FIG. 1B. In a practical application, the platform 14 can further include a multimedia database 142, a text database 144, a first searching interface 146, a second searching interface 148, a searching engine 150, and a selecting module 152, as shown in FIG. 1B.

A plurality of multimedia data (such as ringtones or pop songs) can be stored in the multimedia database 142. The first searching interface 146 can be used for receiving a first search condition from the first terminal 10. For instance, the first search condition can be the name of a pop song. The searching engine 150 can be used for selecting at least one electable multimedia data from the plurality of multimedia data stored in the multimedia database 142 according to the first search condition. Then, the selecting module 152 is used for receiving a first selecting indication from the first terminal 10, and the selecting module 152 selects the multimedia data from the at least one electable multimedia data according to the first selecting indication. The multimedia data is the song which matches the name the most.

In a practical application, a user inputs a text message in the text inputting interface through the first terminal 10, and the text database 144 is capable of providing a plurality of reference text data. For instance, the plurality of reference text data can be a blessing, a joke, or a weather forecast. The second searching interface 148 can be used for receiving a second search condition from the first terminal 10. For instance, the second search condition can be “today's weather” or “happy birthday”. The searching engine 150 is capable of selecting at least one electable text data from the plurality of reference text data stored in the text database 144 according to the second search condition. Then, the selecting module 152 is capable of receiving a second selecting indication from the first terminal 10, and selecting the text data from the at least one electable text data according to the second selecting indication.

In an embodiment, the system 1 according to the invention can further include a charging module (not shown in FIG. 1B) for calculating a charge relative to the text data and/or the multimedia data.

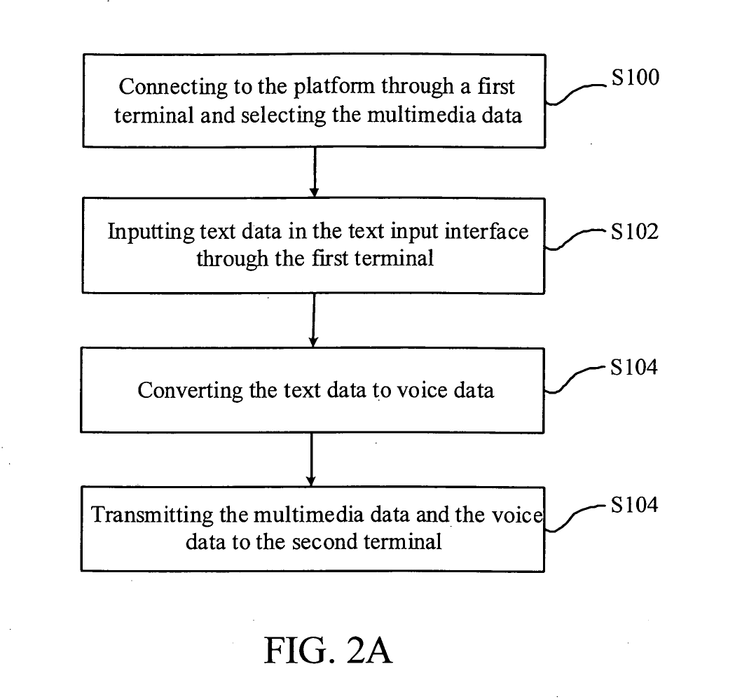

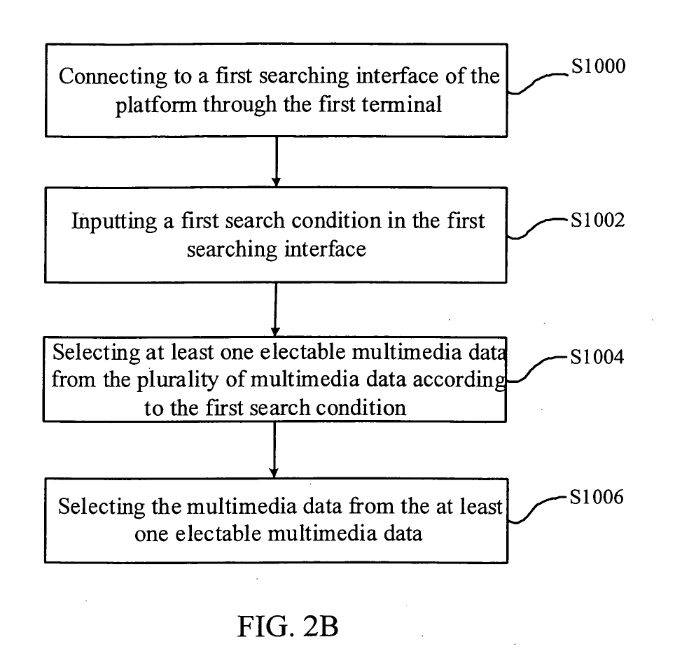

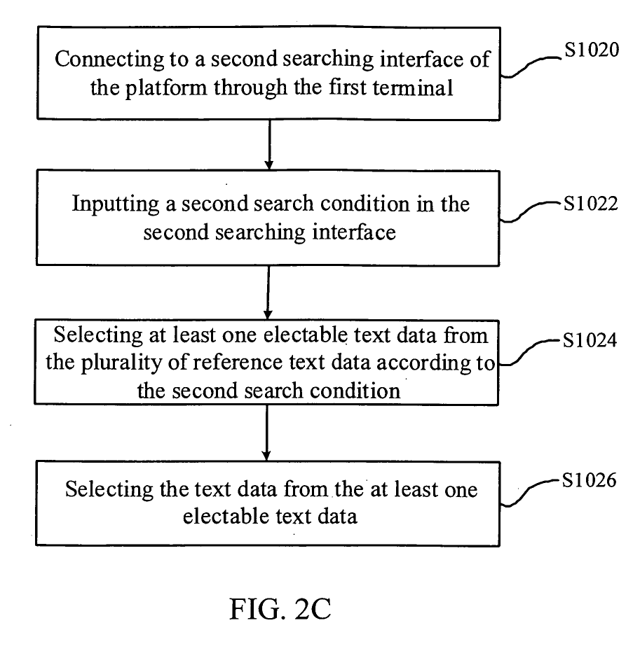

Please refer to FIG. 2A. FIG. 2A is a flow chart showing a method for transforming and transmitting data according to another embodiment of the invention. A platform provides multimedia data and a text input interface. First, the method adopts step S100: connecting to the platform through a first terminal and selecting the multimedia data. Step S102: inputting text data in the text input interface through the first terminal. Step S104: converting the text data to a voice data. Step S106: transmitting the multimedia data and the voice data to the second terminal 12.

In another embodiment, the method can further include a step of calculating a charge relative to the text data and/or the multimedia data.

In a practical application, the platform is capable of providing a plurality of multimedia data, and step. S 100 in FIG. 2A can include step S1000˜S1006, as shown in FIG. 2B. First, the method adopts step S1000: connecting to a first searching interface of the platform through the first terminal. Then, the method adopts step S1002: inputting a first search condition in the first searching interface. After that, the method adopts step S1004: selecting at least one electable multimedia data from the plurality of multimedia data according to the first search condition. Finally, the method adopts step S1006: selecting the multimedia data from the at least one electable multimedia data.

Besides, the platform is capable of providing a plurality of reference text data, and step S102 in FIG. 2A can include step S1020˜S1026, as shown in FIG. 2C. First, the method adopts step S1020: connecting to a second searching interface of the platform through the first terminal. Then, the method adopts step S1022: inputting a second search condition in the second searching interface. After that, the method adopts step S1024: selecting at least one electable text data from the plurality of reference text data according to the second search condition. Finally, the method adopts step S1026: selecting the text data from the at least one electable text data.

The system and the method according to the invention are capable of converting text data to voice data before transmitting the text data, and the content of the text data can be read by playing the voice data. Moreover, the system and the method according to the invention are capable of transmitting the voice data and multimedia data by a terminal to another terminal at the same time. Thus, a user can receive the content of the text data with diversified ways and enjoy the multimedia data.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for transforming and transmitting data, wherein a platform provides a multimedia data and a text input interface, the method comprising the steps of:
(a) connecting to the platform through a first terminal and selecting the multimedia data;
(b) inputting a text data in the text input interface through the first terminal;
(c) converting the text data to a voice data; and
(d) transmitting the multimedia data and the voice data to the second terminal.

2. The method of claim 1, wherein the multimedia data is an audio data.

3. The method of claim 1, wherein in step (d), the multimedia data and the voice data can be immediately transmitted to the second terminal after step (c), or be transmitted to the second terminal after a predetermined time.

4. The method of claim 1, wherein the multimedia data and the voice data are transmitted to the second terminal through an IP-PBX (IP-private branch exchange).

5. The method of claim 1, wherein the platform provides a plurality of multimedia data, and step (a) comprises the steps of:
(a1) connecting to a first searching interface of the platform through the first terminal;
(a2) inputting a first search condition in the first searching interface;
(a3) selecting at least one electable multimedia data from the plurality of multimedia data according to the first search condition; and
(a4) selecting the multimedia data from the at least one electable multimedia data.

6. The method of claim 1, wherein the platform provides a plurality of reference text data, and step (b) comprises the steps of:
(b1) connecting to a second searching interface of the platform through the first terminal;
(b2) inputting a second search condition in the second searching interface;
(b3) selecting at least one electable text data from the plurality of reference text data according to the second search condition; and
(b4) selecting the text data from the at least one electable text data.

7. The method of claim 1, further comprising the step of:
(f) calculating a charge relative to the text data and/or the multimedia data.

8. The method of claim 1, wherein the first terminal is a mobile terminal or a wired terminal.

9. The method of claim 1, wherein the second terminal is a mobile terminal or a wired terminal.

10. A system for transforming and transmitting data, comprising:
a platform, capable of providing a multimedia data and a text input interface;
a first terminal for connecting to the platform and selecting the multimedia data, a user being capable of inputting a text data in the text input interface through the first terminal; and
a transforming module for converting the text data to a voice data, and transmitting the multimedia data and the voice data to a second terminal.

11. The system of claim 10, wherein the multimedia data is an audio data.

12. The system of claim 10, wherein the transforming module is capable of transmitting the multimedia data and the voice data to the second terminal after a predetermined time or transmitting immediately after the text data is converted to the voice data.

13. The system of claim 10, wherein the transforming module transmits the multimedia data and the voice data to the second terminal through an IP-PBX (IP-private branch exchange).

14. The system of claim 10, wherein the platform comprises:
a multimedia database, a plurality of multimedia data being stored in the multimedia database;
a first searching interface for receiving a first search condition from the first terminal;
a searching engine for selecting at least one electable multimedia data from the plurality of multimedia data stored in the multimedia database according to the first search condition; and
a selecting module for receiving a first selecting indication from the first terminal, the selecting module selecting the multimedia data from the at least one electable multimedia data according to the first selecting indication.

15. The system of claim 14, wherein the platform comprises:
a text database, a plurality of reference text data being stored in the text database; and
a second searching interface for receiving a second search condition from the first terminal, the searching engine selecting at least one electable text data from the plurality of reference text data stored in the text database according to the second search condition, the selecting module being capable of receiving a second selecting indication from the first terminal, and selecting the text data from the at least one electable text data according to the second selecting indication.

16. The system of claim 10, further comprising:
a charging module for calculating a charge relative to the text data and/or the multimedia data.

17. The method of claim 10, wherein the first terminal is a mobile terminal or a wired terminal.

18. The method of claim 10, wherein the second terminal is a mobile terminal or a wired terminal.
